(19) United States
(12) Patent Application Publication
(10) Pub. No.: US 2024/0002984 A1
(43) Pub. Date: Jan. 4, 2024

(54) Scrap inventory management method

(71) Applicant: ArcelorMittal, Luxembourg (LU)

(72) Inventors: Borja ENA RODRIGUEZ, Avilés Asturias (ES); Pablo VALLEDOR PELLICER, Avilés Asturias (ES); Alejandro FERNANDEZ ALONSO, Avilés Asturias (ES); Diego DIAZ FIDALGO, Aviles Asturias (ES)

(21) Appl. No.: 18/265,195

(22) PCT Filed: Dec. 1, 2021
(86) PCT No.: PCT/IB2021/061157

§ 371 Date: Jun. 2, 2023

(30) Foreign Application Priority Data
Dec. 3, 2020 (WO) PCT/IB2020/061424

(51) Int. Cl. C22C 33/04; C22B 9/20

(52) U.S. Cl. CPC C22C 33/04; C22B 9/20

(57) ABSTRACT

A scrap inventory management method allowing to have a better control of scrap stocks. The method includes a calculation step of at least one combination of an action to be performed and an associated quantity for a given scrap based on characteristics of the liquid steel to be produced and on scrap properties.

The invention is related to a scrap inventory management method wherein different kind of steel scrap are used to produce liquid steel.

### BACKGROUND

Nowadays steel scrap is commonly used in steelmaking process for the production of liquid steel. Said scrap may be used at different stages along the steelmaking process and in different steelmaking tools. Converter, Basic Oxygen Furnace (BOF), Electric Arc Furnace (EAF) are some of the tools which may notably be used for steelmaking production.

Said scrap may be of different kind, depending notably on their origin or their pre-treatment. Steel scrap is classified in three main categories namely home scrap, new scrap, and old scrap depending on when it becomes scrap in its life cycle.

Home scrap is the internally generated scrap during the manufacturing of the new steel products in the steel plants. It is also known as run-around scrap and is the material in the form of trimmings or rejects generated within a steel plant during the process of the production of iron and steel. This form of scrap rarely leaves the steel plant production area. Instead, it is returned to the steelmaking furnace on site and melted again. This scrap has known physical properties and chemical composition.

New scrap (also called prime or industrial scrap) is generated from manufacturing units which are involved in the fabricating and making of steel products. Scrap accumulates when steel is cut, drawn, extruded, or machined. The casting process also produces scrap as excess metal. New scrap includes such items as turnings, clippings and stampings leftover when parts are made from iron and steel during the manufacturing processes. It is usually transported quickly back to steel plants through scrap processors and dealers or directly back to the steel plant for re-melting to avoid storage space and inventory control costs. The supply of new scrap is a function of industrial activity. When activity is high, more quantity of new scrap is generated. The chemical composition and physical characteristics of new scrap is well known. This scrap is typically clean, meaning that it is not mixed with other materials. In principle new scrap does not need any major pre-treatment process before it is melted, although cutting to size may be necessary.

Old scrap is also known as post-consumer scrap or obsolete scrap. It is steel that has been discarded when industrial and consumer steel products (such as automobiles, appliances, machinery, buildings, bridges, ships, cans, and railway coaches and wagons etc.) have served their useful life. Old scrap is collected after a consumer cycle, either separately or mixed, and it is often contaminated to a certain degree, depending highly on its origin and the collection systems. Since the lifetime of many products can be more than ten years and sometimes even more than fifty years (for example products of building and construction), there is an accumulation of iron and steel products in use since the production of the steel has started on a large scale. Since the old scrap is often material that has been in use for years or decades, chemical composition and physical characteristics are not usually well known. It is also often mixed with other trash.

Kind of scrap and its available quantity is of importance as it has an impact on the process wherein it is used, whether on the quality of the manufactured product or the productivity of the process.

### SUMMARY OF THE INVENTION

Within a steelmaking plant scraps are stored in stockyards, one stockyard per kind of scrap to avoid mixing them. It is important to make sure that each stockyard has a required quantity of a given kind of scrap for the different steelmaking tools where it should be used. However, as many stockyards are present on a site it is not easy to have a clear inventory and some scrap may be missing.

Some methods exist to control scrap stocks in a plant. Document JP2002068478 A describes for example a method to manage scrap inventory wherein each kind of scrap is weighed before being stored in a stockyard. Many information related to the scrap are then collected, such as quality, supplier, net weight, receiving date and price. Then scrap is consumed, and consumed quantity is used as an input to update inventory. This method deals with each stockyard individually and use scrap consumption as an input which does not allow to anticipate any out of stock.

One aim of the present invention is to remedy the drawbacks of the prior art by providing a scrap inventory management method allowing better control of several scrap stocks, notably within several steelmaking plants. Moreover, the method according to the invention allows maintenance of a required level of quality and quantity of the liquid steel to be produced whatever the available quantities of each kind of scrap.

The present invention provides a method, wherein at least two different kind of scrap, each having its own properties and being stored in a stockyard, are used to produce liquid steel having liquid steel characteristics in at least one steelmaking plant, the method comprising the steps of defining for each plant the characteristics of the liquid steel to be produced among a weight, a composition, a temperature, a maximum scrap weight, a minimum scrap weight, a hot metal ratio, a slag weight, a slag composition, a number of heats and a weight per heat; listing for each scrap, scrap properties among an available quantity in a given stockyard, a typology, a density, a size, a pollution level, a chemical composition, an enthalpy; calculating for each scrap at least one combination of an action to be performed among transfer between stockyards, use in the steelmaking plant, refill of the stockyard and an associated quantity of said scrap based on the defined characteristics of the liquid steel to be produced and on the listed scrap properties and performing the calculated action.

The method according to the invention may also comprise the following optional features considered separately or according to all possible technical combinations:
the calculation is performed using a mass balance model,
the liquid steel is produced in at least two plants,
the typology of scrap is chosen among old scrap, new scrap, prime scrap, home scrap, pit scrap, shredded, plates and structure scrap, heavy melting scrap, cast scrap, coil scrap or busheling scrap,
the at least one kind of scrap is prime scrap;
the calculation is performed using a thermodynamical model,
the method is performed each time a new steelmaking campaign is launched, and refill actions are performed at the end of the campaign,
the liquid steel is produced in a converter,
the liquid steel is produced in an Electric Arc Furnace.

### BRIEF DESCRIPTION OF THE DRAWINGS

Other characteristics and advantages of the invention will emerge clearly from the description of it that is given below by way of an indication and which is in no way restrictive, with reference to the appended figures in which:

FIG. 1 is an illustration of a network of steelmaking plants wherein the invention may be performed

FIG. 2 is a flowchart of a method according to the invention.

### DETAILED DESCRIPTION

Elements in the figures are illustration and may not have been drawn to scale.

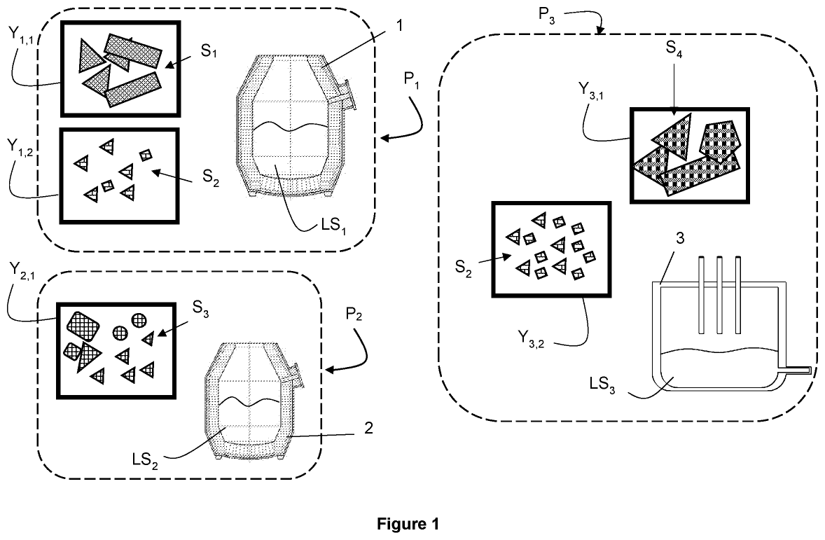

FIG. 1 illustrates a network of steelmaking plants wherein the invention may be performed. The network of plants comprises several steelmaking plants P₁, P₂, P₃, each of them comprising at least one steelmaking tool such as converters 1, 2 or Electric Arc Furnace 3. Each of said steelmaking tool produces a liquid steel LS₁, LS₂, LS₃. Each steelmaking plants P₁, P₂, P₃ further comprises at least one stockyard Y_{1,1}, Y_{1,2}, Y_{2,1}, Y_{3,1}, Y_{3,2}, wherein one kind of scrap S₁, S₂, S₃, S₄ to be used for the steelmaking production is stored. One may understand that one steelmaking plant may comprise several steelmaking tools, each producing a liquid steel while sharing the same stockyards. The method according to the invention would apply similarly.

S₁ may be for example home scrap, such as pit scrap which is a by-product of flat steel products manufacturing process, S₂ maybe old scrap such as shredded scrap which corresponds to old scrap which has usually fragmentized into pieces not exceeding 200 mm in any direction for 95% of the load. S₃ maybe prime scrap, which is a by-product of manufacturing of steel-based products such as plumbing fixtures, automobiles, or electronics. Kinds of scrap may also correspond to a given classification, such as the one used in Europe (see EU27 scrap specification published by European Ferrous Recovery and Recycling Federation in May 2007).

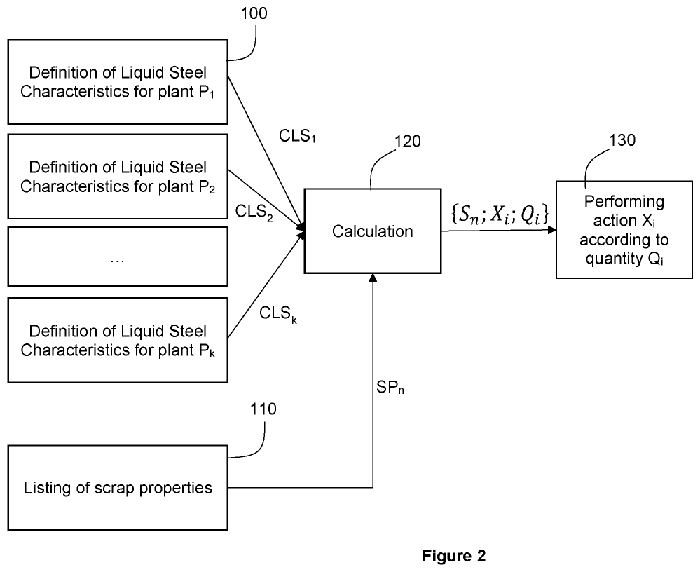

FIG. 2 illustrates a flowchart of an inventory method according to the invention. The first step 100 of the invention consists in defining for each plant Pₖ, the characteristics CLSₖ of the liquid steel LSₖ to be produced in the steelmaking tool. Said characteristics are chosen among a weight of liquid steel to be produced, a composition of the liquid steel to be produced, a temperature of the liquid steel to be produced, a maximum scrap weight to be loaded into the steelmaking tool, a minimum scrap weight to be loaded into the steelmaking tool, a hot metal ratio, a slag weight, a slag composition, a number of heat, a production weight per heat. Those characteristics are expressed in units chosen to be consistent with each other's. Composition of the liquid steel may for example be chosen among a maximum, a minimum or a range of percentage in weight of a given component, such as Carbon, Iron, Sulphur, Phosphorus, Copper, Titanium, Tin or Nickel. The hot metal ratio is the proportion of hot metal vs scrap that is used in the converter. Maximum and minimum scrap weight may be defined for each kind of scrap Sn. A heat corresponds to one production of liquid steel in a converter and depends on the capacity of said converter. A campaign of production of a given liquid steel may comprise several heats, which is why the number of heats and weight of each heat may be among the defined characteristics.

In a second step 110, which can be performed in parallel to the first one 100, the different kind of scrap Sₙ and their properties SPₙ are listed. Those properties are chosen among an available quantity in a given stockyard Y_{k,t}, a density, a size, a pollution level, a chemical composition, an enthalpy, a typology. Composition of the scrap may for example be chosen among a maximum, a minimum or a range of percentage in weight of a given component, such as Carbon, Iron, Sulphur, Phosphorus, Copper, Titanium, Tin or Nickel. Typology may be chosen among prime scrap, old scrap, new scrap, shredded, pit scrap, reuse scrap, plate and structural scrap, heavy melting scrap, coils scrap, cast iron scrap or busheling scrap.

Ferrous scrap is basically classified according to several properties, most notably (i) chemical composition, (ii) level of impurity elements, (iii) physical size and shape, and (iv) homogeneity, i.e. the variation within the given specification. Thus, to one typology may correspond a list of properties.

Plate and structural scrap, often referred to as P&S in the scrap industry, is a cut grade of ferrous scrap, presumed to be free of any contaminates. Plate and structural scrap comprise clean open-hearth steel plates, structural shapes, crop ends, shearing, or broken steel tires. Heavy melting steel (HMS) or heavy melting scrap is a designation for recyclable steel and wrought iron. It is broken up into two major categories: HMS 1 and HMS 2, where HMS 1 does not contain galvanized and blackened steel, whereas HMS 2 does. Both HMS 1 and 2 comprise iron and steel recovered from items demolished or dismantled at the end of their life. Pit scrap is a by-product of flat steel products manufacturing process containing merely scale. Coil scrap contains discarded coils, because of quality issues by example, or residues of coil cutting. Cast Iron Scrap is an alloy of iron that contains high amounts of carbon. The carbon content makes it susceptible to corrosion. As a result, Cast Iron scrap is often rusted and worn. Cast iron scrap can be obtained from heating systems, vehicle components etc. Another kind is busheling scrap constituted of clean steel scrap and include new factory busheling (for example, sheet clippings, stampings, etc.).

Once first 100 and second 110 steps are performed, the third 120 step is performed which consists in calculating for each kind of scrap Sn at least one combination of an action Xi to be performed with an associated quantity Qi. Those actions are chosen among transfer from one stockyard Yk,t to another, use as raw material for the production of liquid steel LSk, refill of a stockyard Yk,t. This calculation is performed taking into account the characteristics CLSk of the liquid steel as defined in first step 100 and the listed scrap properties SPn in the second step 110. It may be performed using a mass balance model, considering how each chemical component behaves in the converter or the electric furnace and thus which part of each scrap goes to liquid steel or to the slag. It may also include thermodynamic model considering notably the enthalpy of each scrap, hot metal and slag to ensure the proper temperature operating point for each liquid steel.

Once all combinations have been calculated all calculations Xᵢ are performed in a fourth step 130 and the liquid steel LSₖ is then produced.

With the method according to the invention it is possible to have an accurate control of the scrap stocks to insure a continuous production of liquid steel at the required level of quality and productivity.

Moreover, with the method according to the invention it is possible to keep required level of quality and production level of liquid steel even when higher scrap grades, such as prime scrap, are less available by calculating appropriate scrap mix among available kinds of scrap.

### Example

### Input Data

The method is applied to three plants P1, P2, P3:
Plant P1 with a converter for production of Liquid Steel LS1. Plant P1 has three stockyards, Y1,1 storing scrap S1, stockyard Y1,2 storing scrap S2 and stockyard S2 storing scrap S3.
Plant P2 with a converter for production of liquid steel LS2. Plant P2 has three stockyards, Y2,1 storing scrap S1, Y2,2 storing scrap S2 and stockyard Y2,3 storing scrap S4.
Plant 3 with a converter for production of liquid steel LS3. Plant 3 has four stockyards, Y3,1 storing scrap S1, Y3,2 storing scrap S2 and stockyard Y3,2 storing scrap S3 and Y3,4 storing scrap S4.

This is summed up in table 1 below:

TABLE 1

| Plant | P1 | | | P2 | | | P3 | | | |
|---|---|---|---|---|---|---|---|---|---|---|
| Stockyard | Y1, 1 | Y1, 2 | Y1, 3 | Y2, 1 | Y2, 2 | Y2, 3 | Y3, 1 | Y3, 2 | Y3, 3 | Y3, 4 |
| Scrap | S1 | S2 | S3 | S1 | S2 | S4 | S1 | S2 | S3 | S4 |

### Liquid Steel Characteristics

Characteristic CLS1, CL2, CLS3 of liquid steel LS1, LS2 and LS3 are listed in table 2 below. N/A means Not Applicable, no constraint needed on this parameter. Percentage are percentage in weight % w.

TABLE 2

| | Weight | % Min | % Max | % Max | % Max | % Max | % Max |
|---|---|---|---|---|---|---|---|
| Ref | (ton) | Fe | Cr | S | Sn | Cu | Ni |
| LS1 | 304200 | 99 | 0.065 | 0.03 | 0.01 | 0.063 | 0.046 |
| LS2 | 37700 | 98.8 | N/A | N/A | 0.02 | 0.06 | N/A |
| LS3 | 24453 | 98.5 | 0.4 | 0.04 | 0.03 | 1.3 | 2 |

### Scrap Properties

Properties SP1, SP2, SP3, SP4 of each kind of scrap S1, S2, S3, S4 are listed in table 3 below.

Percentage indicated are average percentage in weight of each component in scrap.

Quantity are expressed in tons.

TABLE 3

| | S1 | S2 | S3 | S4 |
|---|---|---|---|---|
| Typology | HMS#1 | P&S | shredded | Pit scrap |
| Quantity in plant P1 | 1222 | 6865 | 0 | 3890 |
| Quantity in plant P2 | 0 | 1060 | 0 | 2500 |
| Quantity in plant P3 | 287 | 1803 | 3566 | 2336 |
| % Fe | 95.5 | 97 | 92 | 83 |
| % Cr | 0.25 | 0.2 | 0.12 | 0.03 |
| % S | 0.05 | 0.03 | 0.05 | 0.013 |
| % Sn | 0.015 | 0.03 | 0.02 | 0.01 |
| % Cu | 0.4 | 0.2 | 0.25 | 0.03 |
| % Ni | 0.2 | 0.1 | 0.12 | 0.01 |
| Density (kT/m³) | 0.9611 | 0.9611 | 2.0183 | 1.1213 |

### Results

Calculation step (130) of the method according to the invention is then performed based on above mentioned liquid steel characteristics and scrap properties. Results are illustrated in table 4 below.

TABLE 4

| Scrap | Action Xi | Quantity Qi (tons) |
|---|---|---|
| S1 | Use in P1 | 0 |
| S1 | Refill of stockyard Y1, 1 | 437 |
| S1 | Transfer from stockyard Y1, 1 | 1000 |
| | to stockyard Y2, 1 | |
| S2 | Use in P1 | 21509 |
| S2 | Refill of stockyard Y1, 2 | 24525 |
| S4 | Use in P1 | 3502 |
| S4 | Refill of stockyard Y1, 3 | 0 |
| S1 | Use in P2 | 800 |
| S1 | Refill of stockyard Y2, 1 | 0 |
| S2 | Use in P2 | 260 |
| S2 | Refill of stockyard RD_Y2, 2 | 0 |
| S4 | Use in P2 | 2300 |
| S4 | Refill of stockyard Y2, 3 | 0 |
| S1 | Use in P3 | 2087 |
| S1 | Refill of stockyard Y3, 1 | 2800 |
| S2 | Use in P3 | 3691 |
| S2 | Refill of stockyard Y3, 2 | 3648 |
| S3 | Use in P3 | 8158 |
| S3 | Refill of stockyard Y3, 3 | 7592 |
| S4 | Use in P4 | 1482 |
| S4 | Refill of stockyard Y3, 4 | 0 |

Using the inventory method according to the invention it has been possible to produce the liquid steel in the three different plants using available scrap and to still have scrap stocks for next production campaign.

What is claimed is:

1-9. (canceled).

10. A method of managing scrap inventory wherein at least two different kind of scrap (Sₙ), each having its own properties (SPₙ) and being stored in a stockyard (Y_{k,t}), are used to produce liquid steel (LSₖ) having liquid steel characteristics (CLSₖ) in at least one steelmaking plant (Pₖ) , the method comprising the following steps:
defining for each plant (Pₖ) the liquid steel characteristics (CLSₖ) to be produced among a weight, a composition, a temperature, a maximum scrap weight, a minimum scrap weight, a hot metal ratio, a slag weight, a slag composition, a number of heats and a weight per heat;
listing for each scrap (Sₙ), scrap properties (SPₙ), among an available quantity in a given stockyard (Y_{k,t}), a typology, a density, a size, a pollution level, a chemical composition, an enthalpy;
calculating for each scrap (Sₙ) at least one combination of an action (Xᵢ) to be performed among transfer between stockyards (Y_{k,t}), use in the steelmaking plant (Pₖ), refill of the stockyard (Y_{k,t}) and an associated quantity (Qᵢ) of the scrap based on the defined characteristics (CLSₖ) of the liquid steel to be produced and on the listed scrap properties (SPₙ); and
performing the calculated action (Xᵢ) for the associated quantity (Qᵢ).

11. The method as recited in claim 10 wherein the calculation is performed using a mass balance model.

12. The method as recited in claim 10 wherein the liquid steel is produced in at least two plants P1, P2.

13. The method as recited in claim 10 wherein the typology of scrap is chosen among old scrap, new scrap, prime scrap, home scrap, pit scrap, shredded, plates and structure scrap, heavy melting scrap, cast scrap, coil scrap or busheling scrap.

14. The method as recited in claim 10 wherein at least one kind of scrap (Sₙ) is prime scrap.

15. The method as recited in claim 10 wherein the calculation is performed using a thermodynamical model.

16. The method as recited in claim 10 wherein the method is performed each time a new steelmaking campaign is launched, and refill actions are performed at the end of the campaign.

17. The method as recited in claim 10 wherein the liquid steel is produced in a converter.

18. The method as recited in claim 10 wherein the liquid steel is produced in an Electric Arc Furnace.
